(19) United States
(12) Patent Application Publication
(10) Pub. No.: US 2010/0073308 A1
(43) Pub. Date: Mar. 25, 2010

(54) TOUCH PANEL AND ELECTRONIC DEVICE THEREOF

(75) Inventors: Ming-Hua Yeh, Taipei City (TW); Yi-Cheng Peng, Hsinchu County (TW); Shih-Chang Chu, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SWENC Technology Co., Ltd., Taoyuan County (TW)

(21) Appl. No.: 12/331,370

(22) Filed: Dec. 9, 2008

(30) Foreign Application Priority Data
Sep. 22, 2008 (TW) 97136342

(51) Int. Cl. G06F 3/041

(52) U.S. Cl. 345/173

(57) ABSTRACT

A touch panel and an electronic device thereof are provided. The touch panel includes a film, a substrate and a plurality of dot spacers. The dot spacers are disposed on a surface of the substrate, and the surface faces the film. In addition, the height of the dot spacers in each unit size of the substrate progressively decreases from the vertical-axis direction of the center of the substrate to the horizontal axis direction thereof.

### CROSS-REFERENCE TO RELATED APPLICATION

This application claims the priority benefit of Taiwan application serial no. 97136342, filed on Sep. 22, 2008. The entirety of the above-mentioned patent application is hereby incorporated by reference herein and made a part of this specification.

### BACKGROUND OF THE INVENTION

1. Field of the Invention

The present invention relates to a touch panel, more particularly, the present invention relates to a touch panel with uniform touch force and an electronic device thereof.

2. Description of the Related Art

With the rapid and staggering progress of science and technologies, many electronic devices (for example, PDA, cellular phone, etc.) are mostly equipped with a touch panel for promoting the operation convenience thereof. Among various kinds of the current touch panels, since the resistive touch panel can use any things (for example, touch pen, fingers, business cards, etc.) to be an input medium, and the accuracy and the response time of judging touch positions thereof are quite high and fast. Accordingly, the resistive touch panel becomes popular in the market recently.

FIG. 1 is a simple cross-sectional view of a conventional resistive touch panel 100. Referring to FIG. 1, the resistive touch panel 100 is composed of an indium tin oxide (ITO) transparent conductive film 101, an ITO transparent conductive glass 103, a frame 105 and a plurality of dot spacers 107 disposed on a surface of the ITO transparent conductive glass 103. General knowledge, a position touched between the ITO transparent conductive film 101 and the ITO transparent conductive glass 103 is pressed by users.

However, since the dot spacers 107 are uniformly distributed on the surface of the ITO transparent conductive glass 103 in general, so that the magnitude of the touch force really felt by users pressing the resistive touch panel 100 would progressively increase from the vertical-axis direction of the center position of the ITO transparent conductive glass 103 to the horizontal-axis direction thereof (as shown in FIG. 2's curve A). Accordingly, users will feel that the magnitude of pressing the around of the resistive touch panel 100 is greater than the magnitude of pressing the center position of the resistive touch panel 100.

### SUMMARY OF THE INVENTION

The present invention is directed to a touch panel which achieves that the touch force of whole touch panel is uniform.

The present invention provides a touch panel including a film, a substrate and a plurality of dot spacers. The dot spacers are disposed on a surface of the substrate. The mentioned surface of the substrate faces the film. The height of the dot spacers in each unit size of the substrate progressively decreases from a vertical-axis direction of a center position of the substrate to a horizontal-axis direction thereof.

According to an embodiment of the present invention, the volume of the dot spacers in each unit size of the substrate progressively decreases from the vertical-axis direction of the center position of the substrate to the horizontal-axis direction thereof.

According to an embodiment of the present invention, the number of the dot spacers in each unit size of the substrate either progressively decreases from the vertical-axis direction of the center position of the substrate to the horizontal-axis direction thereof or the same.

The present invention also provides an electronic device having the above mentioned touch panel.

According to the above embodiment of the present invention, the touch panel further includes a frame disposed around the substrate for fixing the film on the substrate.

According to the above embodiment of the present invention, the height of the frame is higher than the height of the dot spacers.

According to the above embodiment of the present invention, the material of the frame is at least one of the electric conductivity material and the non-electric conductivity material.

According to the above embodiment of the present invention, the film is an indium tin oxide (ITO) transparent conductive film.

According to the above embodiment of the present invention, the substrate is an ITO transparent conductive glass.

According to the above embodiment of the present invention, the touch panel is a resistive touch panel.

Since the dot spacers of the touch panel of the present invention are not uniformly disposed on the ITO transparent conductive glass as conventional, and the height of/the number of/the volume of the dot spacers in each unit size of the ITO transparent conductive glass progressively decreases from the vertical-axis direction of the center of the ITO transparent conductive glass to the horizontal axis direction thereof, so that the touch force of whole touch panel will be uniformly, and users will feel that the magnitude of pressing the around of the resistive touch panel is approximate to the magnitude of pressing the center position of the resistive touch panel.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a simple cross-sectional view of a conventional resistive touch panel.

FIG. 2 is a diagram of the pressing positions of a conventional resistive touch panel and a curve of the touch force thereof.

FIG. 3 is a cross-sectional view of a touch panel according to an embodiment of the present invention.

FIG. 4 is a distribution diagram of the number of the dot spacers in each unit size of the substrate according to an embodiment of the present invention.

FIG. 5 is a diagram of the pressing positions of a resistive touch panel and a curve of the touch force thereof according to an embodiment of the present invention.

FIG. 6 is a cross-sectional view of a touch panel according to another embodiment of the present invention.

FIG. 7 is a distribution diagram of the number of the dot spacers in each unit size of the substrate according to another embodiment of the present invention.

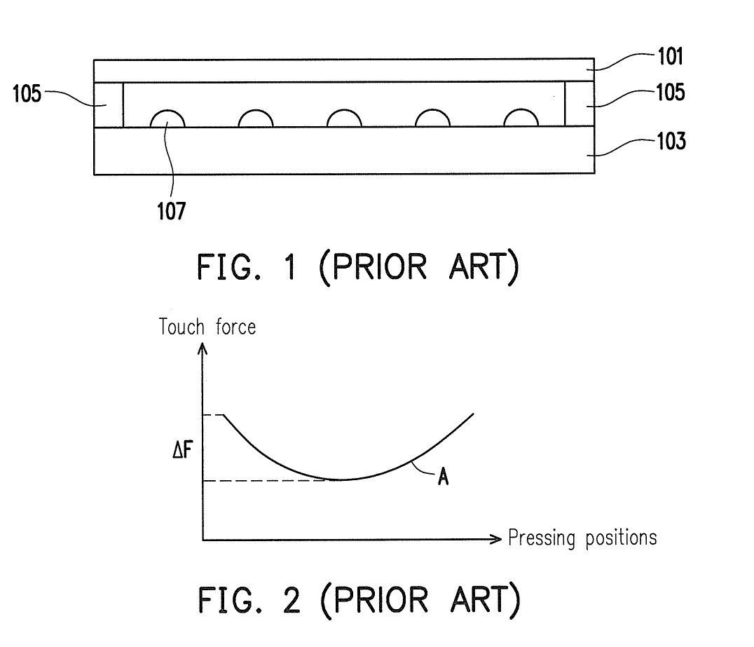

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention wants to achieve that the touch force of whole touch panel is uniform. Below, the characteristics and advantages of the technique in the present invention will be described in detail.

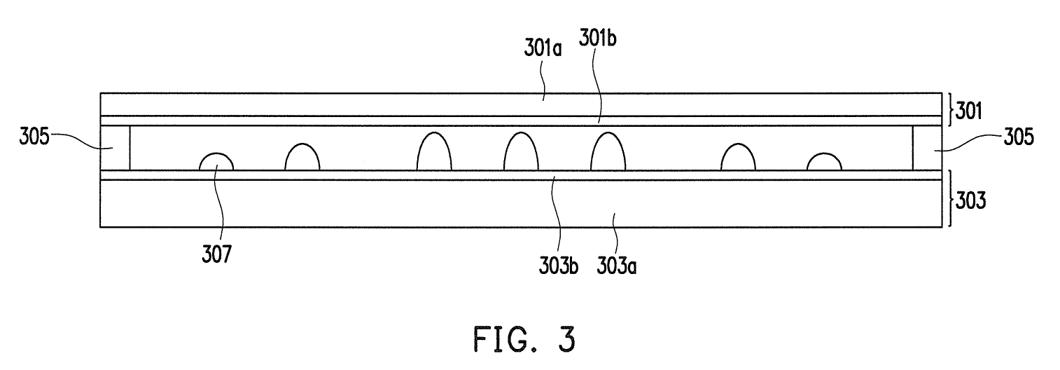

FIG. 3 is a cross-sectional view of a touch panel 300 according to an embodiment of the present invention. Referring to FIG. 3, the touch panel 300 includes a film 301, a substrate 303, a frame 305 and a plurality of dot spacers 307. In the present embodiment, the film 301 includes a polyester (PET) film 301a, and an indium tin oxide (ITO) conductive layer 301b would be sputtered on the under surface of the PET film 301a, so that the film 301 would be formed an ITO transparent conductive film. The substrate 303 includes a glass 303a, and an ITO conductive layer 303b would be sputtered on the upper surface of the glass 303a, so that the substrate 303 would be formed an ITO transparent conductive glass.

The frame 305 would be disposed around the substrate 303 for fixing the film 301 on the substrate 303. In the present embodiment, the material of the frame 305 may be an electric conductivity material (for example, silver, but not limited thereto) or a non-electric conductivity material (for example, twin adhesive, but not limited thereto), and the height of the frame 305 is higher than the height of the dot spacers 307.

The dot spacers 307 are disposed on a upper surface, which has sputtered the ITO conductive layer, of the substrate 303, and this surface would face the film 301. In the present embodiment, the height of each of the dot spacers 307 would progressively decrease from the vertical-axis direction of the center position of the substrate 303 to the horizontal-axis direction thereof. In addition, the volume of each of the dot spacers 307 would progressively decrease from the vertical-axis direction of the center position of the substrate 303 to the horizontal-axis direction thereof. Furthermore, the number of the dot spacers 307 in each unit size of the substrate 303 would either progressively decrease from the vertical-axis direction of the center position of the substrate 303 to the horizontal-axis direction thereof or the same.

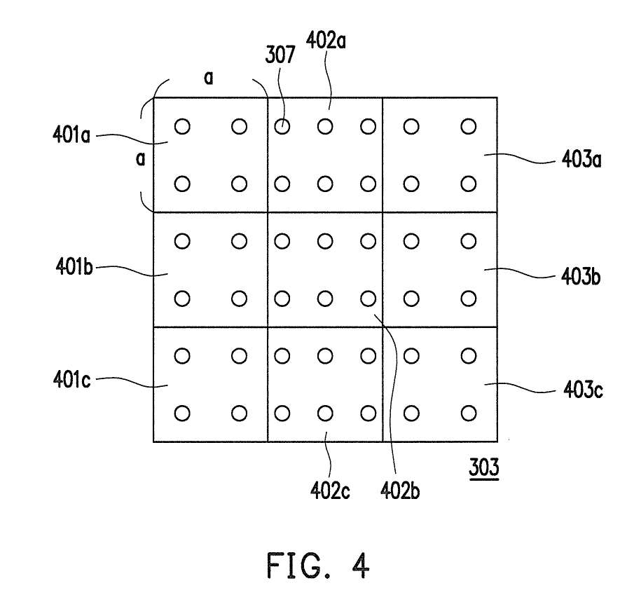

To be specific, FIG. 4 is a distribution diagram of the number of the dot spacers 307 in each unit size (a*a) of the substrate 303 according to an embodiment of the present invention. Referring to FIG. 3 and FIG. 4, it can be seen in FIG. 4 clearly, the present embodiment would be divided the substrate 303 into nine regions 401a˜401c, 402a˜402c and 403a˜403c which have the same unit size (a*a). However, the number of the regions can be changed by the practical design requirement. Each of the regions 402a˜402c has six dot spacers 307, however, the number of and the distribution state of the dot spacers 307 in the regions 402a˜402c are not limited as shown in FIG. 4. Each of the regions 401a˜401c and 403a˜403c has four dot spacers 307, however, the number of and the distribution state of the dot spacers 307 in the regions 401a˜401c and 403a˜403c are not limited as shown in FIG. 4 also.

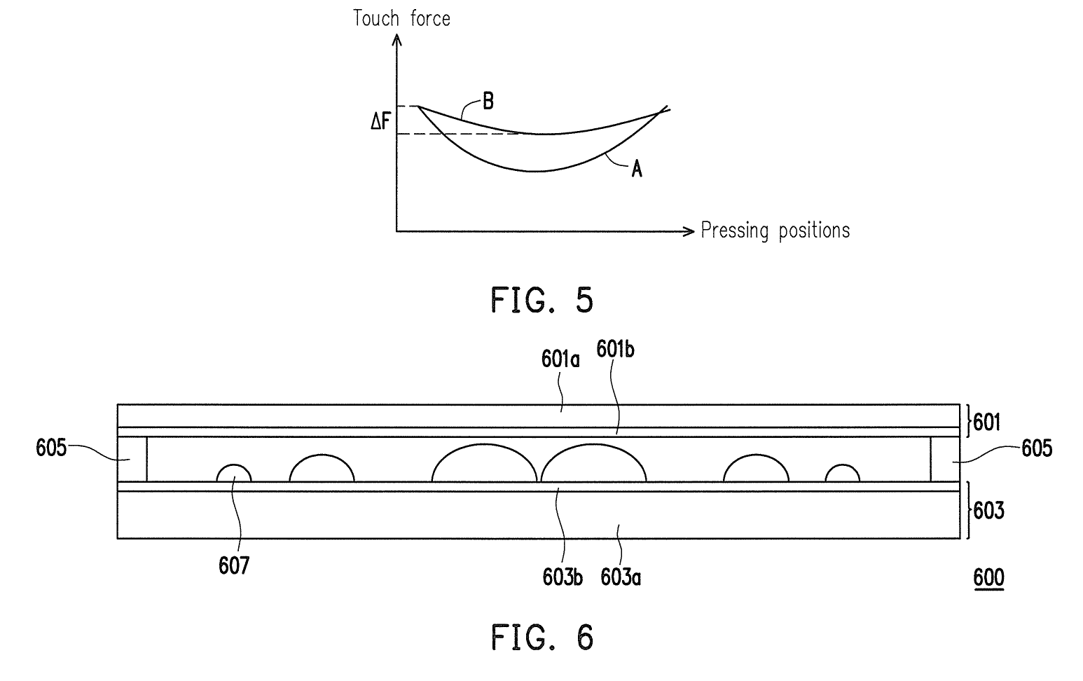

Accordingly, since the height of and the number of the dot spacers 307 in the regions 402a˜402c are higher than and greater than the number of the dot spacers 307 in the regions 401a˜401c and 403a˜403c, and the dot spacers 307 in the regions 402a˜402c are closely to the film 301 than the dot spacers 307 in the regions 401a˜401c and 403a˜403c, so that when the film 301 above the regions 401a˜401c, 402a˜402c and 403a˜403c is pressed by users, the touch force really felt by users will be uniformly (as shown in FIG. 5's curve B). Therefore, the present embodiment can effectively improve the disadvantages mentioned in the Description of the Related Art.

However, the present invention is not limited as the above embodiment. Below, another touch panel will submit to the skilled in the art.

FIG. 6 is a cross-sectional view of a touch panel 600 according to another embodiment of the present invention. Referring to FIG. 3 and FIG. 6, the touch panel 600 includes a film 601, a substrate 603, a frame 605 and a plurality of dot spacers 607, wherein the film 601, the substrate 603 and a frame 605 are respectively the similar as the film 301, the substrate 303 and a frame 305, so their descriptions are omitted herein.

In addition, the height of each of the dot spacers 607 still progressively decreases from the vertical-axis direction of the center position of the substrate 603 to the horizontal-axis direction thereof, and the number of the dot spacers 607 in each unit size of the substrate 603 is the same. Furthermore, the volume of the dot spacers 607 in each unit size of the substrate 603 would progressively decrease from the vertical-axis direction of the center position of the substrate 603 to the horizontal-axis direction thereof.

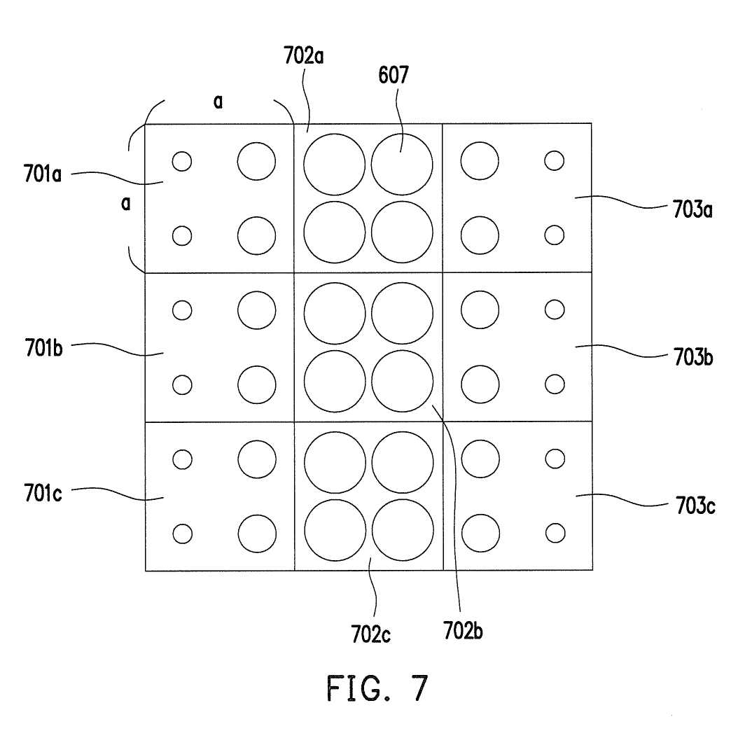

To be specific, FIG. 7 is a distribution diagram of the number of the dot spacers 607 in each unit size (a*a) of the substrate 603 according to another embodiment of the present invention. Referring to FIG. 6 and FIG. 7, it can be seen in FIG. 7 clearly, the present embodiment would be divided the substrate 603 into nine regions 701a˜701c, 702a˜702c and 703a˜703c which have the same unit size (a*a). However, the number of the regions can be changed by the practical design requirement. Each of the regions 701a˜701c, 702a˜702c and 703a˜703c has four dot spacers 607, however, the number of and the distribution state of the dot spacers 607 in the regions 701a˜701c, 702a˜702c and 703a˜703c are not limited as shown in FIG. 7.

Moreover, the height of and the volume of the dot spacers 607 in the regions 702a˜702c are the highest and the biggest, and closely to the film 601, while the height of and the volume of the dot spacers 607 tending to the regions 701a˜701c and 703a˜703c would progressively decrease and far to the film 601. Accordingly, since the height of and the volume of the dot spacers 607 in the regions 702a˜702c are higher than and bigger than the height of and the volume of the dot spacers 607 in the regions 701a˜701c and 703a˜703c, so that when the film 601 above the regions 701a˜701c, 702a˜702c and 703a˜703c is pressed by users, the touch force really felt by users will be uniformly (as shown in FIG. 5's curve B). Therefore, the present embodiment also can effectively improve the disadvantages mentioned in the Description of the Related Art.

In summarized the above embodiments, any embodiments for achieving the touch force being uniformly by changing the height, the distribution density and volume of the dot spacers in the touch panel would fall in the scope of the present invention. In addition, any electronic devices having the touch panel submitted by the present invention would also fall in the scope of the present invention.

In summary, since the dot spacers of the touch panel of the present invention are not uniformly disposed on the ITO transparent conductive glass as conventional, and the height of/the number of/the volume of the dot spacers in each unit size of the ITO transparent conductive glass progressively decreases from the vertical-axis direction of the center of the ITO transparent conductive glass to the horizontal axis direction thereof, so that the touch force of whole touch panel will be uniformly, and users will feel that the magnitude of pressing the around of the resistive touch panel is approximate to the magnitude of pressing the center position of the resistive touch panel.

It will be apparent to those skills in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel, comprising:
a film;
a substrate; and
a plurality of dot spacers, disposed on a surface of the substrate and the surface facing the film;
wherein a height of the dot spacers in each unit size of the substrate progressively decreases from a vertical-axis direction of a center position of the substrate to a horizontal-axis direction thereof.

2. The touch panel according to claim 1, wherein a volume of the dot spacers in each unit size of the substrate progressively decreases from the vertical-axis direction of the center position of the substrate to the horizontal-axis direction thereof.

3. The touch panel according to claim 1, wherein the number of the dot spacers in each unit size of the substrate either progressively decreases from the vertical-axis direction of the center position of the substrate to the horizontal-axis direction thereof or the same.

4. The touch panel according to claim 1, further comprising:
a frame, disposed around the substrate, for fixing the film on the substrate.

5. The touch panel according to claim 4, a height of the frame is higher than the height of the dot spacers.

6. The touch panel according to claim 4, wherein a material of the frame is at least one of an electric conductivity material and a non-electric conductivity material.

7. The touch panel according to claim 1, wherein the film is an indium tin oxide (ITO) transparent conductive film.

8. The touch panel according to claim 1, wherein the substrate is an ITO transparent conductive glass.

9. The touch panel according to claim 1, wherein the touch panel is a resistive touch panel.

10. An electronic device having the touch panel as claimed in claim 1.
